(19) United States
(12) Patent Application Publication
(10) Pub. No.: US 2013/0311250 A1
(43) Pub. Date: Nov. 21, 2013

(54) METHODS AND ARRANGEMENTS FOR IMPROVING DRIVING SAFETY

(71) Applicants: David W. Hickethier, Harrisburg, PA (US); Evan L. Keller, New Cumberland, PA (US)

(72) Inventors: David W. Hickethier, Harrisburg, PA (US); Evan L. Keller, New Cumberland, PA (US)

(21) Appl. No.: 13/710,289

(22) Filed: Dec. 10, 2012

Related U.S. Application Data
(60) Provisional application No. 61/647,945, filed on May 16, 2012.

(51) Int. Cl. G06Q 30/02

(52) U.S. Cl. CPC G06Q 30/0207
USPC 705/14.1

(57) ABSTRACT

Methods and apparatus encouraging distraction-free driving using at least a server and a mobile colt Cat ion device are disclosed. The method includes implementing challenges having challenge parameters, the challenge pertaining to encouraging the distraction-free driving. The method also includes tracking trip data and measuring the trip data against the challenge parameters. The method also includes administering at least a monetary-based or non-monetary-based reward to a user who accomplishes the challenge by satisfying the challenge parameters.

### PRIORITY CLAIM

This application claims priority under 35 USC. 119(e) to a commonly-owned provisional patent application entitled “METHODS AND ARRANGEMENTS FOR IMPROVING DRIVING SAFETY”, U.S. application No. 61/647,945, filed on May 16, 2012 by Hickethier et al., all of which are incorporated herein by reference.

### BACKGROUND OF THE INVENTION

The harm caused from distracted driving is in many cases irreparable, and just as often, entirely preventable. Mobile communication devices (including cellular phones, smart phones, tablets, laptops, in-dash devices, etc.) have in many cases been implicated in accidents involving distracted drivers. The distraction that involves mobile communication devices (MCD) may include, for example, texting, internet surfing, video viewing, map viewing, etc, or even voice calling with or without the use of a headset. Generally speaking, a mobile communication device is a communication device that can be networked (such as a smart phone or a tablet connectable to a network using cellular signals or WiFi) or can be stand-alone (such as a tablet that is used for watching a pre-recorded video, for example). When the driver engages in an MCD-related distraction, that driver poses significant risks of property damage, bodily harm, or even death to himself, others in his vehicle, and/or other third parties.

Using the capabilities of mobile communication devices and employing a reward-based paradigm that takes advantage of capabilities of mobile communication devices to motivate drivers to refrain from engaging in MCD-related distractions while driving are among the main goals of the instant patent application.

### BRIEF DESCRIPTION OF THE DRAWINGS

The present invention is illustrated by way of example and not by way of limitation, in the figures of the accompanying drawings and in which like reference numerals refer to similar elements and in which:

FIG. 1 shows, in accordance with an embodiment of the invention, some example metrics for a challenge, including miles driven and trip duration.

FIG. 2 shows, in accordance with an embodiment of the invention, an example of a screen for checking into locations.

FIG. 3 shows, in accordance with an embodiment of the invention, an example DF user display screen depicting a challenge.

FIG. 4 shows, in accordance with an embodiment of the invention, an example DF user display screen depicting the relative standings of various DF users in a challenge.

FIG. 5 shows, in accordance with an embodiment of the invention, an example DF user display screen depicting the various challenges available.

FIG. 6 shows, in accordance with an embodiment of the invention, an example DF user status screen depicting relative standing among various users in an example competition over the course of several days and spanning different challenges.

FIG. 7 shows, in accordance with an embodiment of the invention, an example DF user status screen pertaining to a challenge.

FIG. 8 shows, in accordance with an embodiment of the invention, an example DF user sponsor request goal through which a DF user may request a sponsor.

FIG. 9 shows, in accordance with an embodiment of the invention, another example DF user sponsor request screen through which the DF user may specify the prize to be won from a restaurant and from a personal sponsor in order to request sponsorship.

FIG. 10 shows, in accordance with an embodiment of the invention, an example DF user display screen depicting a social network implementation of the DF app in which messages are posted on a “wall.”

FIG. 11 shows, in accordance with an embodiment of the invention, the steps for managing a challenge using the DF server.

FIG. 12 shows, in accordance with an embodiment or the invention, some execution steps performed by the DF app in implementing the reward-based distraction-free driving method.

FIG. 13 shows, in accordance with an embodiment of the invention, a simplified conceptual drawing of the DF server/app environment.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include any of the data processing devices, including for example smart phones, tablet computers, laptop computers, or a general-purpose computers and/or dedicated computing devices when appropriately programmed and may include a combination of a computer/computing device and dedicated/programmable circuits adapted for the various tasks pertaining to embodiments of the invention. Such a data processing device include, as is well-known, at least a processor unit, a memory unit, a graphic processing unit, a data storage unit (such as a hard drive or semiconductor-based data storage device), one or more I/O circuits, one or more data communication sub-systems, and/or operating system/applications for executing executable code. Data processing devices are well-known and are not discussed in greater detail herein for brevity's sake.

Embodiments of the invention relate to methods and arrangements for encouraging drivers to stay focused on driving while earning rewards for not using their mobile communication devices. As the term is employed herein, a reward is an incentive that may be (but not necessarily have to be) financially-motivated. Although a reward may, in one or more embodiments, be cash or a gift certificate or a coupon that has cash value when redeemed, a reward may also be intangible. For example, a high rank in a game that satisfies a person's competitive spirit may be a reward in one or more embodiments. As another example, an opportunity to play a challenging or fun game may be a reward, in one or more embodiments.

In one or more embodiments, an MCD-implemented, reward-based method that incentives drivers to engage in MCD-free travel is disclosed. The MCD-implemented method has multiple challenges with different rewards associated therewith for successful completion. In addition to reward-based challenges, the user (such as the driver) may also receive sponsorship from friends and family for successful completion of any challenge that user accepts.

In the following example, an application that is loaded on a smart phone is employed for discussion purposes. The application implements the method of the invention. However, the invention is not limited to the example discussed herein (or to pre-loaded apps or to smart phones, for example) and may cover all equivalents and extensions obvious to those skilled in the art.

For ease of reference, the app implementing the method of the invention is referred to herein as the Distraction-Free (DF) app. Such DF app may include software-implemented program(s) installed or executed on an MCD (including for example smart phones, tablets, dedicated GPS devices, notebook computers, laptop computers, digital audio players, digital video players, gaming devices, in-dash console devices, etc.). A DF server, communicable to the MCD via the wireless/cellular interface, may be employed to collect data acquired or tracked by the individual DF apps and may perform back-end functions to implement the challenges, sponsors, and other data harvesting/data processing functions, as will be discussed later herein.

In an embodiment, the user may initiate the DF app when preparing to start a trip. For example, the user may initiate the DF app upon entering the vehicle or upon driving. Once opened, the user may select the start button, and the DF app may use GPS or any another location-determining technology (including for example cellular phone triangulation or WiFi locating) to track how quickly the user is moving.

In an embodiment, once a pre-determined activation speed (vehicle is moving) is reached, the DF app may be automatically started and/or may automatically start capturing data. In other embodiments, data tracking may start upon initiating the DF app or upon selecting the previously mentioned start button.

While the DF app is executing and the user is traveling on a trip, if the user engages in distracted driving behaviour using the MCD (e.g., answering phone or text or watching a movie or surfing the net), the DF app deems the user to have engaged in distracted driving behavior during the trip and rewards may be withheld and/or a penalty may be levied as will be discussed later herein.

The DF app continues to capture the trip-related data as long as the user doesn't leave the app for any reason. In an embodiment, when the user moves at a speed slower than the activation speed, the app displays a finish button for the user to indicate the trip is over. This allows the user to temporarily stop execution of the DF tracking without being penalized since the act of slowing down below a threshold may indicate an intention to legitimately use the MCD (e.g., answering the phone or email or text) in a manner that is safe and the user should not be penalized to the point of not bothering to slow down in the future when needing to use the MCD for making a call, for example.

If the finish button is not selected and the user again reaches activation speed the app continues tracking the current trip. This tracking continues until the user has completed your trip (e.g., by pushing the “finish” button at the end of the trip).

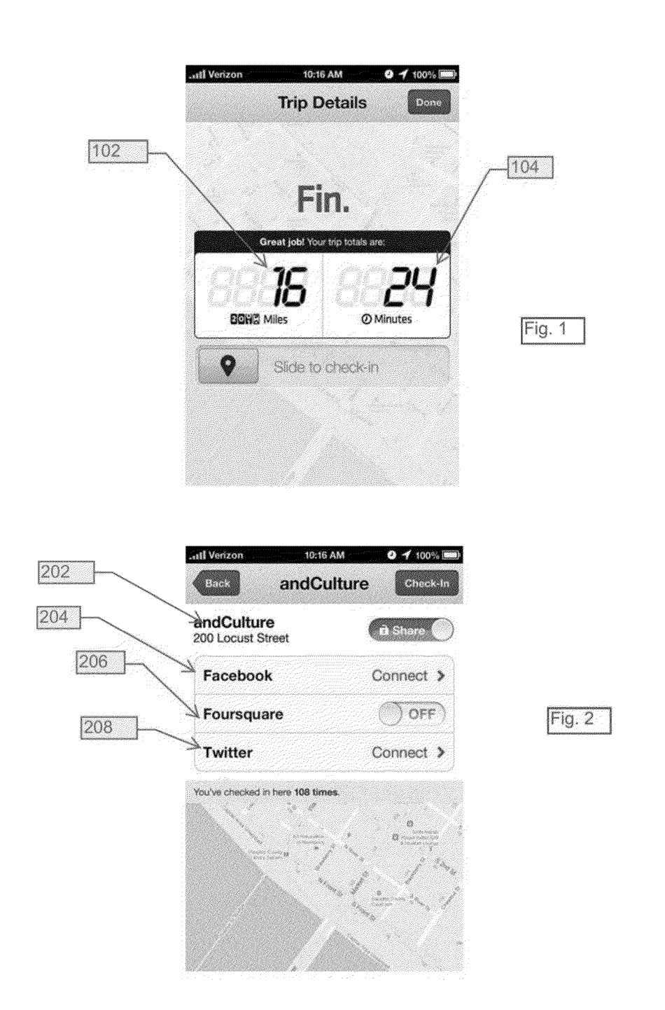

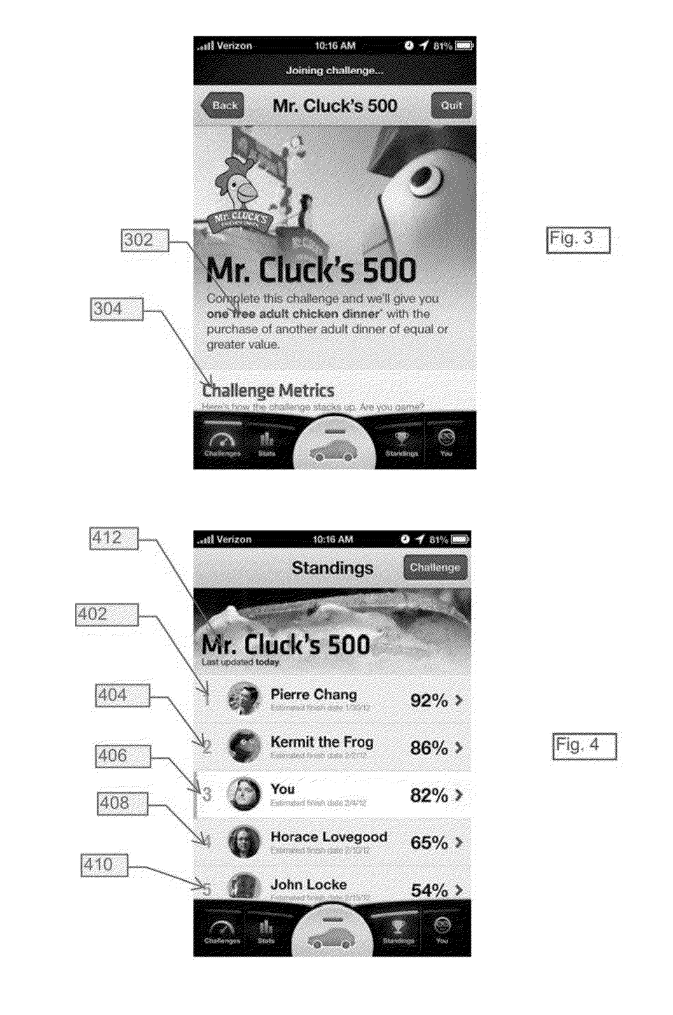

Once the trip is deemed finished, the trip data is added to the user's status data for each challenge the user has entered. In one or more embodiments, the DF app tracks up to four (or more) metrics while driving with the DF app engaged. In some DF apps, these metrics include for example Miles/Km driven, Time spent, Number of trips taken, and the places the user has checked into while using DF. FIG. 1 shows, in accordance with an embodiment of the invention, some example metrics including miles driven (102) and trip duration (104). FIG. 2 shows, in accordance with an embodiment of the invention, an example of a screen for checking into location “200 Locust Street” (202) via different social networks (204, 206, and 208).

Challenges are determined by using some or all of these metrics to create a unique challenge. In one or more embodiments, the calculation of these metrics is as follows.
A. Miles driven—While driving with DF app open, GPS data is employed to determine how many miles/km the user has driven while exceeding the activation speed.
B. Time spent—While driving with DF open, the hours:minutes:seconds of the trip is tracked.
C. Trips taken—Each trip that is successfully completed is counted as an individual trip.
D. Places the user has checked into—The user can check into locations upon the completion of your trip. Checking in may include manually or automatically initiating an action that signifies the user is at the location and/or may be performed using pre-existing technology and tool such as those offered by the websites Facebook™, Yahoo™, Google™, Yelp™, and Foursquare™.

In one or more embodiments of the invention, individuals and companies may create challenges for the user. For example, there may be at least a few types of challenges such as group and individual challenges, private and public challenges, timed and repeat challenges. These challenges may be created via a browser via a laptop or desktop computer or via a tablet or smart phone, for example, and parameters (i.e., requirements for passing a challenge, rewards associated with a challenge, etc.) associated with the challenges may be stored at the DF server for implementing the challenges for the DF app users being challenged.

In one or more embodiments, the goal of these challenges is to motivate the user/driver to refrain from engaging in MCD-related distracted driving by using the competition and/or reward mechanism. The challenge may relate to, for example, the number of trips successfully completed in a manner that is free of MCD-related distracted driving behavior. Alternatively or additionally, the challenge may relate to, for example, the number of miles/km successfully completed in a manner that is free of MCD-related distracted driving behavior. Alternatively or additionally, the challenge may relate to, for example, the number of check-in locations successfully completed in a manner that is free of MCD-related distracted driving behavior. Any of the collected metrics or combination of collected metrics or derivatives thereof may be employed to create a challenge.

Achieving a challenge may entitle the user to some tangible or intangible prizes or recognition, for example. An example type of challenge is to group challenge whereby individuals can join teams and compete against other teams in the challenge. Another example type of challenge is an individual challenge whereby individuals can compete against other individuals in challenges. Another example type of challenge is private challenge whereby individuals or groups are included on an invite-only basis. Another example type of challenge is a public challenge whereby the general public is allowed to participate in these challenges. Another type of challenge is timed challenge whereby the challenges are time-limited so that a participant can only attempt to complete them until the allotted time runs out. Another type of challenge is repeat challenges whereby a user is allowed to attempt the challenge several times. A repeat challenge may also be a rolling challenge that repeats itself endlessly, in one or more embodiments.

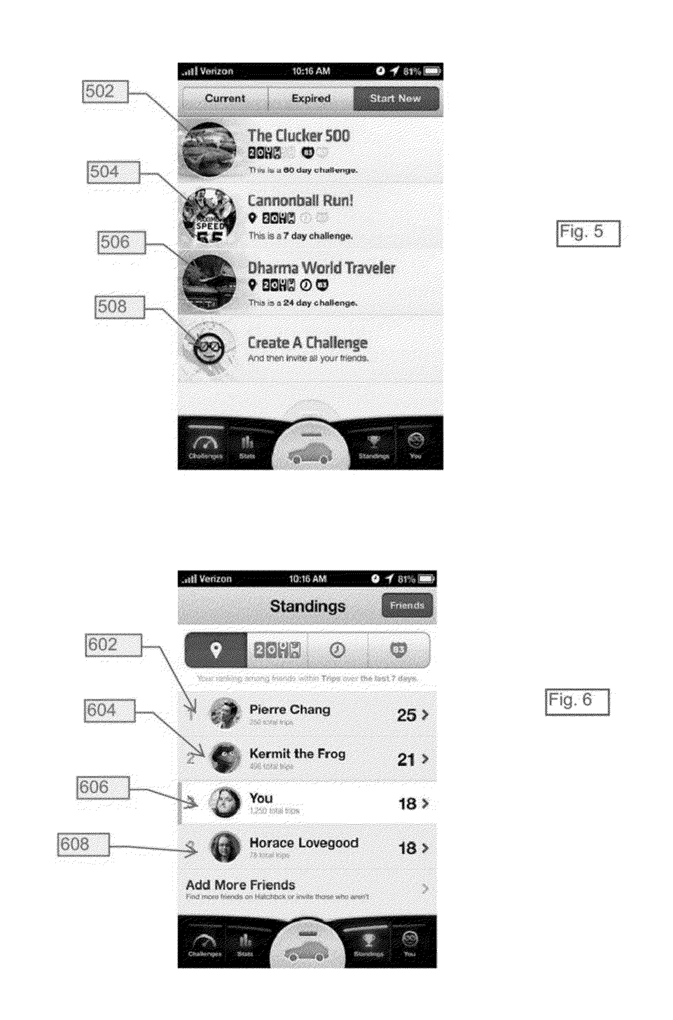

FIG. 3 shows, in accordance with an embodiment of the invention, an example DF user display screen showing a challenge known as “Mr. Cluck's 500”, along with the reward “one free adult chicken dinner” (302) and the metrics for measuring challenge performance (304). FIG. 4 shows, in accordance with an embodiment of the invention, an example DF user display screen showing the relative standings of various DF users 402, 404, 406, 408, and 410 competing in the challenge “Mr. Cluck's 500” (412).

In one or more embodiments, sponsorships may be implemented in one or more embodiments, there may exist two types of sponsorship: organization-based challenge sponsors and personal sponsors. Organization-based challenge sponsorship may include companies or individuals who can sponsor challenges. An organization-based challenge sponsor will typically provide rewards for the sponsored challenge. The rewards may be monetary, prizes, discounts, or other incentives for the completion of the challenge. Some challenge sponsors may decide to have a challenge built to a custom specification that may include special game dynamics or contest rules.

Personal sponsors may include friends or family members who may volunteer or who may be requested to sponsor a challenge. A DF user can have one (or many) sponsor(s) for all challenges in which they are participating. The sponsor may offer a reward to the user they've sponsored for the successful completion of the challenge.

FIG. 5 shows, in accordance with an embodiment of the invention, an example DF user display screen depicting the various challenges available (502, 504, 506, and 508). FIG. 6 shows, in accordance with an embodiment of the invention, an example DF user status screen depicting relative standing among various users (602, 604, 606, and 608) in an example competition over the course of several days and spanning different challenges.

In an example, a merchant may sign up with the DF server to sponsor a challenge. A merchant may, alternatively or additionally, sign up with the DF server to purchase driving-related data (e.g., route taken, demographics, etc) acquired by the DF server from the DF apps in order to allow the merchant to better tailor offers, discounts, coupons to entice DF users to purchase goods/services. Such offers, discounts, or coupons and the merchant's requirements that a DF user must satisfy in order to be entitled to receive the offers, discounts, or coupons may be received by the DF server from the merchant. The DF server may then administer such offers, discounts, or coupons using the data acquired from the DF apps. The DF server may also settle accounting (e.g., by billing for the administering the offers/discounts/coupons or for the sale of acquired driving/demographics data or for the providing of other data obtained from or derived from the DF apps data feeds) with the merchant as part of the administration of the offers, discounts, coupons and/or challenges on behalf of the merchants.

In one or more embodiment, the DF app is part of a DF ecosystem (or platform) that encourages sharing with and challenging friends and family using various social networks (Facebook™, Twitter™, Foursquare™, Yelp™, Google™, etc.). For example, trip data, challenges, invitations, and additional status updates may be shared via social networks.

In one or more embodiments, the user is penalized for leaving the DF app. Penalty may take the form of losing accumulated metrics for that trip, in an embodiment. For example, if the user drives for 15 miles and in 24 minutes and before the trip is finished, the text message (or phone) is received and the user leaves the app to respond. When the user returns to the DF app, the metrics earned for that trip up to the time when the user responds to the text/phone message would be forfeited, and the user would start accumulating metrics i.e., starting from zero) for the remainder of the trip.

In one or more embodiments, GPS locations along roads may be designated by a challenge sponsor or by the DF server or others as markers. These GPS markers may be pre-announced or may be randomly assigned without prior announcement to the users. A user may accumulate point(s) and/or earn rewards (such as a coupon for goods or services or a discount for the purchase thereof) by passing those GPS markers while using the DF app for the trip. In this manner, the user is encouraged to use the DF app for trips.

In one or more embodiments, the user may lose the ability to collect point(s) and/or reward(s) while on a trip if the user is ascertained by the DF app as having engaged in distracted driving (i.e., using the MCD during driving) during that trip prior to reaching or while passing a GPS marker.

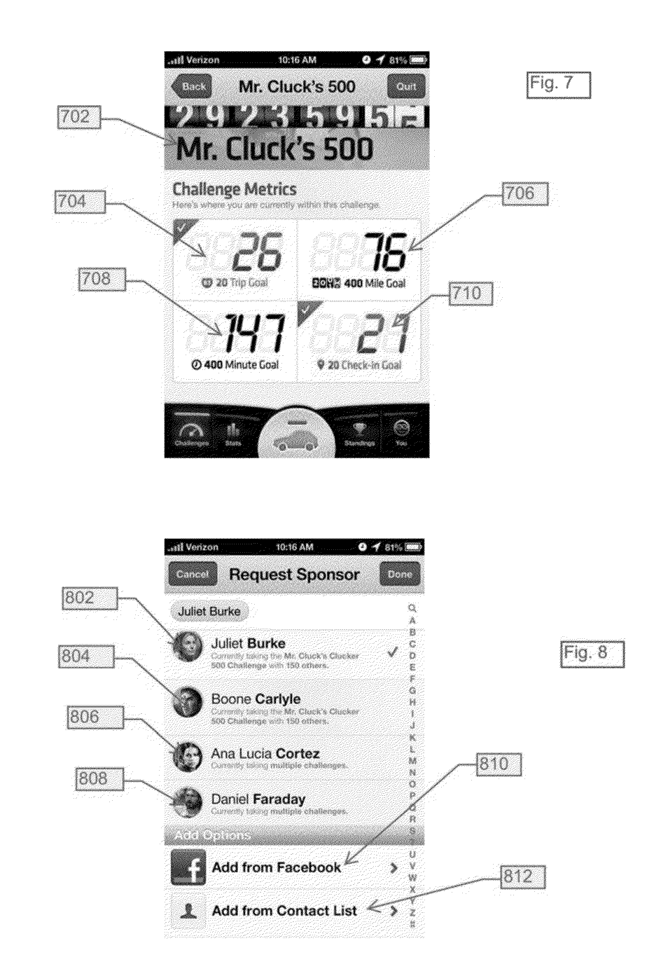

FIG. 7 shows, in accordance with an embodiment of the invention, an example DF user status screen pertaining to the challenge “Mr. Cluck's 500” (702). Various metrics are tracked, including number of trips (704), mile goal (706), minute goal (708), and Check-in Goal (710). In this example, the DF user has surpassed his number of trips (704) goal and his Check-in (710) goals and thus these are highlighted in green. Other goals (706 and 708) remain black, signifying that they have not been achieved.

FIG. 8 shows, in accordance with an embodiment of the invention, an example DF user sponsor request goal through which a DF user may request a sponsor (802) from his address book that also contains contact 804, 806, and 808. Other options for adding contacts from social network (810) and from other contact list (812) are also shown.

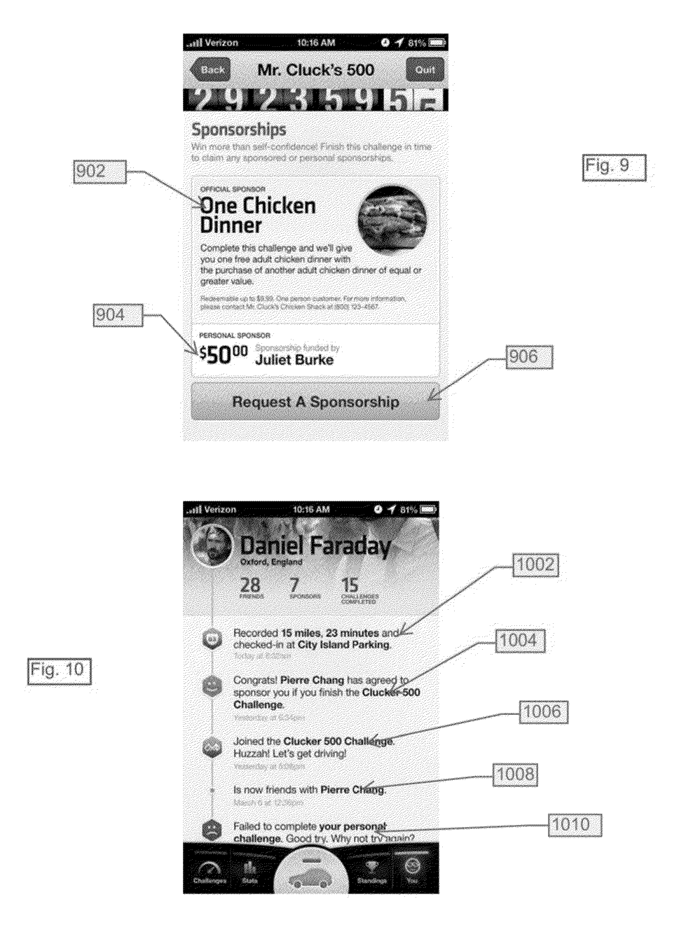

FIG. 9 shows, in accordance with an embodiment of the invention, another example DF user sponsor request screen through which the DF user may specify the prize to be won from a restaurant (902) and from a personal sponsor (904) in order to request sponsorship (906). FIG. 10 shows, in accordance with an embodiment of the invention, an example DF user display screen depicting a social network implementation of the DF app in which messages (1002, 1004, 1006, 1008 and 1010) are posted on a “wall.”

Additionally, one or more embodiments may penalize in other ways a DF user who engaged in distracted driving prior to passing or while passing such a GPS marker. In an example, some or all the points and/or rewards accumulated for that trip by that user may be virtually “dropped” or “deposited” with that GPS marker such “drop” would be tracked by the DF server, for example). The next DF user (or a random DF) user that passes that GPS marker subsequent to such points/rewards being “dropped” would be rewarded some or all of the points/rewards “dropped” at that GPS marker. In this manner, DF users are discouraged from distracted driving (due to risk of losing accumulated points/rewards) while being encouraged to log on and to stay log on (due to chance of accumulating points/rewards and also chance of picking up points/rewards dropped by users who were found to engage in distracted driving).

In one or more embodiments, the DF server may track driving patterns via the DF apps. The driving data (e.g., which route a person takes and when) may be correlated with profile data (e.g., age, sex, past rewards redeemed, past purchases, etc.) to gain additional behavioral insights into the demographics traversing a certain route. In addition, data collected from connected social platforms (Facebook™, Twitter™, Google™, Yelp™, Foursquare™, Amazon™, etc.) may be correlated with the driving data. This information, or an aggregate/anonymous version thereof, may be provided to merchants targeting a particular geographic region, to allow them to better tailor offers and/or discounts to entice these DF users to purchase goods/services.

For example, a merchant may be provided with data from the DF server about the number of 18-22 year-old drivers passing a particular location from 3 PM to 5 PM Monday through Friday. In one or more embodiments, the DF server anonymizes the data such that privacy for the DF users is preserved. This information may allow the merchant to better tailor his offering to such drivers, for example. In one or more embodiments, the offers may be made only to DF users who have deemed to have earned their “rewards” (e.g., only to DF users who have not engaged in distracted driving during their current trips or during N past trips). In another embodiment, the offer may be made to all DF users to maximize sales, for example.

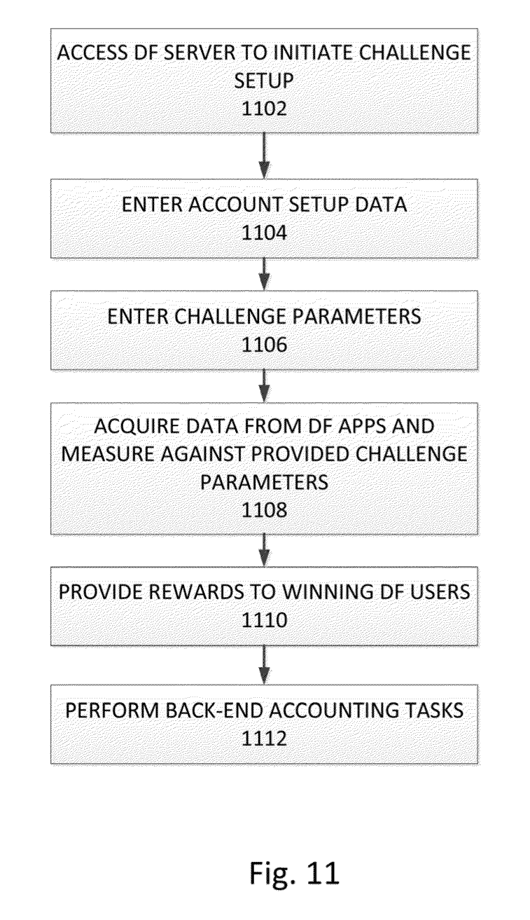

FIG. 11 shows, in accordance with one or more embodiments, the steps for managing a challenge using the DF server. One or more embodiments of the invention may employ some or all of these steps of FIG. 11. In step 1102, a person or a company (such as a merchant) (referred to in this example as the “challenge sponsor”) accesses the DF server to initiate a challenge set-up. Accessing the DF server may be performed using a browser on a laptop or desktop computer or using an appropriate app on a tablet or a smart phone, for example. In step 1104, the challenge sponsor may enter data to set up an account with the DF server, including personal/company identifying data and any accounting-related data (e.g., for the settlement of invoices for the services offered by the DF server or for the cost of administering the challenge or discount or offer or coupon or for data purchased).

In step 1106, the challenge sponsor provides the DF server with parameters associated with the challenges. These parameters may include any metrics that the DF users being challenged would be measured against during the course of the challenge. The parameters may also include any threshold parameter value (if any) that the DF users being challenged must achieve prior to being deemed eligible for a reward. The parameters may also include the rewards (e.g., monetary or non-monetary) to be awarded when the DF users are deemed to have earned these rewards.

In step 1108, data is acquired from the DF users via the DF apps and measured against the parameters provided in step 1106. In step 1110, rewards, if any, are provided to the “winning” DF user via the DF app if that DF user is deemed to have “earned” the rewards based on the parameters entered in step 1106. In step 1112, back-end accounting tasks are performed in order to, for example, collect fees from the challenge sponsor for administering the challenge and/or providing the advertising and/or providing the coupons/rewards/discounts.

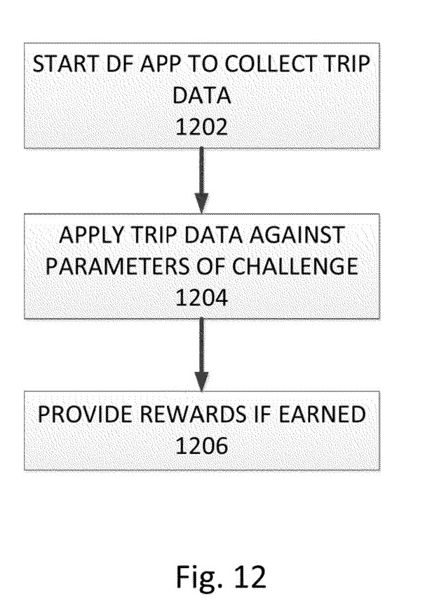

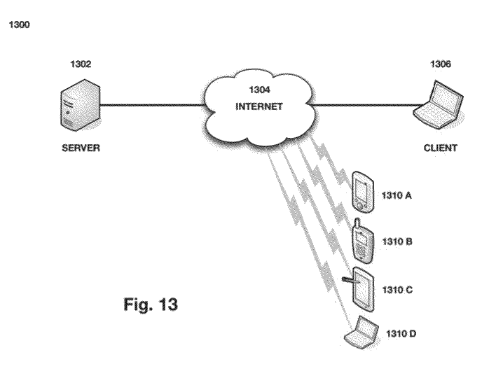

FIG. 12 shows, in accordance with one or more embodiments, some execution steps performed by the DF app in implementing the reward-based distraction-free driving method. In step 1202, the DF app is started. A user may manually starts the DF app or the DF app may be automatically started to begin collecting data when the user's speed exceeds a certain threshold speed for example. In step 1204, the user's trip data (e.g., velocity, duration, route, etc.) may be applied against parameters associated with any challenge or game that the user participates in, whether voluntarily by the user or automatically offered by the DF server. In step 1204, penalties may be applied against the DF user (e.g., debited from the user's DF account) based on trip data acquired during step 1204 if the DF user is deemed to have engaged in distracted driving.

In step 1206, reward (monetary-based and/or non-monetary based) may be offered or provided to the DF user (e.g., credited to the DF user's account) based on the trip data acquired during step 1204 (e.g., if the DF user is deemed to have earned a reward).

FIG. 13 shows, in accordance with an embodiment of the invention, a simplified conceptual drawing of an example DF server/app environment 1300. DF server 1302 (which may be a single server or a cluster of servers and may represent physical or virtual servers) is shown coupled to the internet 1304 to communicate with one or more clients 1306. As is well-known, internet 1304 is a collection of servers and communication paths and devices (switches, routers, cellular towers, optical fibers, copper conductors, etc.) for exchanging analog or digital information.

A client 1306 may represent a browser executing on a laptop computer or a desktop computer or an app executing on a tablet or a smart phone, for example. Using client 1306, a person may sign up to be a DF user. Alternatively or additionally, a challenge sponsor may use a user interface (such as a browser) at client 1306 to sign up to sponsor a challenge for one or more DF users. Alternatively or additionally, a merchant may use client 1306 to sign up to purchase data acquired from the DF apps (which data may Be aggregated, correlated or otherwise processed by DF server 1302).

A plurality of DF apps 1310A, 1310B, 1310C, and 1310D are shown coupled to internet 1304. Each of the DF apps represents software executing on MCDs (which may he smart phones, tablets, laptops, in-dash consoles) through which the user's driving behavior is tracked. Communication between the MCDs executing the DF apps and server 1302 may take place via cellular signals (e.g., GSM or CDMA) or via other wireless technologies (e.g., WiFi, WiMax, etc.).

As can be appreciated from the foregoing, embodiments of the invention encourage distraction-free driving utilizing a reward-based paradigm. For the DF user, various incentives are provided to stay log-on to the DF app and to refrain from distracted driving. For challenge sponsors or merchants, a user-friendly and efficient platform and/or system is provided to provide incentives to encourage DF app users to refrain from distracted driving and/or to take advantage of the data acquired from the DF apps to improve sales or profits for goods/services offered.

While this invention has been described in terms of several preferred embodiments, there are alterations, permutations, and equivalents, which fall within the scope of this invention. If the term “set” is employed herein, such term is intended to have its commonly understood mathematical meaning to cover zero, one, or more than one member. It should also be noted that there are many alternative ways of implementing the methods and apparatuses of the present invention. The invention should be understood to also encompass these alterations, permutations, and equivalents. Although various examples are provided herein, it is intended that these examples be illustrative and not limiting with respect to the invention.

What is claimed is:

1. A computer implemented method for implementing reward-based distraction-free driving, comprising:
receiving, via a computer network, challenge parameters pertaining to a challenge from a server, said challenge pertaining to encouraging said distraction-free driving:
tracking, using software implemented in a mobile communication device, trip data;
measuring said trip data against said challenge parameters; and
providing reward data pertaining to at least one reward if said trip data satisfies said challenge parameters for receiving a reward, said reward data being displayed on a display screen of said mobile communication device, said at least one reward representing one of a monetary-based reward and a non-monetary-based reward.

2. The computer-implemented method of claim 1 wherein said mobile communication device is a smart-phone.

3. The computer-implemented method of claim 1 wherein said mobile communication device is a tablet computer.

4. The computer-implemented method of claim 1 wherein said mobile communication device is a built-in in-dash electronic device in an automobile.

5. The computer-implemented method of claim 1, wherein said challenge is provided by an organization.

6. The computer-implemented method of claim 1 wherein said at least one reward pertains to a discount for one of service and product offered by a merchant.

7. The computer-implemented method of claim 1 wherein said at least one reward is non-monetary-based.

8. The computer-implemented method of claim 1 wherein information pertaining to a user's performance in said challenge is posted to a social network.

9. The computer-implemented method of claim 1 wherein said challenge parameters in includes at least one of trip miles without distracted driving and trip minutes without distracted driving.

10. The computer-implemented method of claim 1 further comprising providing said trip data to said server.

11. A computer-implemented method for implementing reward-based distraction-free driving, comprising:
receiving at a server challenge parameters pertaining to a challenge from a challenge sponsor, said receiving being accomplished using a client interface via a computer network, said challenge pertaining to said distraction-free driving;
sending challenge parameters pertaining to said challenge to at least one mobile communication device;
receiving indication from said at least one mobile communication device whether a user of said mobile communication device satisfies said challenge parameters; and
providing data pertaining to at least one reward to be displayed on a display screen of said at least one mobile communication device if said user of said mobile communication device satisfies said challenge parameters.

12. The computer-implemented method of claim 11 wherein said mobile communication device is a smart-phone.

13. The computer-implemented method of claim 11 wherein said mobile communication device is a tablet computer.

14. The computer-implemented method of claim 11 wherein said mobile communication device is a built-in in-dash electronic device in an automobile.

15. The computer-implemented method of claim 11 wherein said at least one reward pertains to a discount for one of service and product offered by a merchant.

16. The computer-implemented method of claim 11 wherein said at least one reward is non-monetary-based.
